(19) United States
(12) Patent Application Publication
(10) Pub. No.: US 2016/0093978 A1
(43) Pub. Date: Mar. 31, 2016

(54) Latch for Electrical Connector

(71) Applicant: Tyco Electronics Corporation, Berwyn, PA (US)

(72) Inventors: Michael John Phillips, Camp Hill, PA (US); Randall Robert Henry, Harrisburg, PA (US)

(21) Appl. No.: 14/499,465

(22) Filed: Sep. 29, 2014

(51) Int. Cl. H01R 13/629

(52) U.S. Cl. CPC H01R 13/62905

(57) ABSTRACT

A latch is provided for latching a connector to a device. The latch includes a body having an actuator and a latch pin. The latch pin is movable between a latched position and an unlatched position. The latch pin is configured to latch the connector to the device when the latch pin is in the latched position. The actuator extends from the latch. The actuator is configured such that movement of the actuator moves latch pin between latched position and the unlatched position. The actuator and the latch pin are integrally fabricated from a same sheet of material as a continuous structure such that the body is a single, unitary body.

### BACKGROUND OF THE INVENTION

The subject matter described and/or illustrated herein relates generally to electrical connectors, and more particularly to latches for electrical connectors.

Electrical connectors often include latches for latching the electrical connector to another device, such as, but not limited to, another connector, a common housing for a mated pair of connectors, a cage for a pluggable transceiver module, and/or the like. At least some known latches for electrical connectors include auto-return springs that bias the latch to the latched position thereof.

Known latches for electrical connectors are not without disadvantages. For example, at least some known latches for electrical connectors are bulky and may occupy more space than is desired on a housing of the electrical connector. By occupying valuable housing space, such known latches may increase the overall size of the electrical connector, harm the form factor of the electrical connector, and/or harm the aesthetics of the electrical connector. For example, at least some known latches may snag on other objects, structures, and/or the like, for example during mating of the electrical connector with a corresponding mating connector.

### BRIEF DESCRIPTION OF THE INVENTION

In an embodiment, a latch is provided for latching a connector to a device. The latch includes a body having an actuator and a latch pin. The latch pin is movable between a latched position and an unlatched position. The latch pin is configured to latch the connector to the device when the latch pin is in the latched position. The actuator extends from the latch. The actuator is configured such that movement of the actuator moves latch pin between latched position and the unlatched position. The actuator and the latch pin are integrally fabricated from a same sheet of material as a continuous structure such that the body is a single, unitary body.

In an embodiment, an electrical connector includes a housing, an electrical contact assembly held by the housing, and a latch mounted to the housing for latching the electrical connector to a device. The latch includes a body having an actuator and a latch pin. The latch pin is movable between a latched position and an unlatched position. The latch pin is configured to latch the electrical connector to the device when the latch pin is in the latched position. The actuator extends from the latch pin. The actuator is configured such that movement of the actuator moves the latch pin between the latched position and the unlatched position. The actuator and the latch pin are integrally fabricated from a same sheet of material as a continuous structure such that the body is a single, unitary body.

In an embodiment, an electrical connector includes a housing having a sidewall. The electrical connector also includes an electrical contact assembly held by the housing, and a latch mounted to the housing for latching the electrical connector to a device. The latch includes a body having an actuator and a latch pin. The latch pin is movable between a latched position and an unlatched position. The latch pin is configured to latch the electrical connector to the device when the latch pin is in the latched position. The actuator extends from the latch pin. The actuator is configured such that movement of the actuator moves the latch pin between the latched position and the unlatched position. The electrical connector includes a return spring operatively connected with the body such that the return spring is configured to bias the latch pin to the latched position. The return spring is embedded within the sidewall of the housing.

### BRIEF DESCRIPTION OF THE DRAWINGS

FIG. 1 is a partially cut-away perspective view of an embodiment of an electrical connector assembly.

FIG. 2 is a perspective view of an embodiment of an electrical connector of the electrical connector assembly shown in FIG. 1.

FIG. 3 is a perspective view of an embodiment of a latch of the electrical connector shown in FIG. 2.

FIG. 4 is a partially cut-away perspective view of the electrical connector shown in FIG. 2 illustrating the latch shown in FIG. 3 mounted thereto.

FIG. 5 is a partially cut-away perspective view illustrating a cross-section of a portion the electrical connector assembly shown in FIG. 1.

FIG. 6 is a perspective view of another embodiment of an electrical connector of the electrical connector assembly shown in FIG. 1.

FIG. 7 is a perspective view of an embodiment of a latch of the electrical connector shown in FIG. 6.

FIG. 8 is a partially cut-away perspective view of the electrical connector shown in FIG. 6 illustrating the latch shown in FIG. 7 mounted thereto.

### DETAILED DESCRIPTION OF THE INVENTION

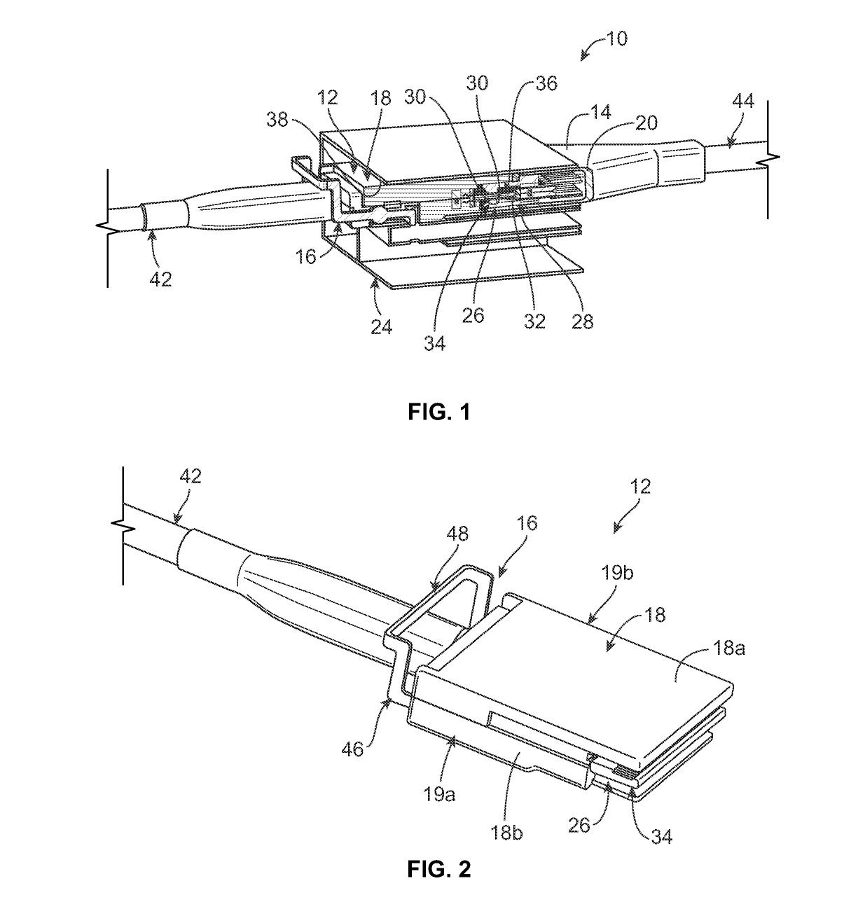

FIG. 1 is a partially cut-away perspective view of an embodiment of an electrical connector assembly 10. The electrical connector assembly 10 includes electrical connectors 12 and 14 that mate together to establish an electrical connection therebetween. As will be described below, at least one of the electrical connectors 12 and/or 14 includes a latch 16 for latching the electrical connector 12 or 14 to another device, such as, but not limited to, a housing 18 or 20 of the other respective electrical connector 12 or 14, a cage (not shown) of a receptacle assembly (not shown) for a pluggable transceiver module (not shown), a common housing 24 for the electrical connectors 12 and 14, and/or the like.

As shown in FIG. 1, each of the electrical connectors 12 and 14 includes a respective electrical contact assembly 26 and 28 held by the respective housing 18 and 20. When the electrical connectors 12 and 14 are mated together as shown in FIG. 1, the electrical contact assemblies 26 and 28 are engaged in electrical contact with each other to establish the electrical connection between the electrical connectors 12 and 14. Each electrical contact assembly 26 and 28 may include any electrically conductive structure that enables the electrical connectors 12 and 14 to communicate data and/or electrical power therebetween. Examples of such electrically conductive structures include, but are not limited to, electrical signal contacts, electrical ground contacts, electrical power contacts, circuit boards, and/or the like. In the illustrated embodiment, the electrical contact assemblies 26 and 28 include respective electrical contacts 30 and 32 that engage in physical contact with each other to establish the electrical connection between the electrical connectors 12 and 14. Although the electrical contact assembly 26 of the electrical connector 12 is shown as including a plug 34 that is received within a receptacle 36 of the electrical connector 14, additionally or alternatively any other arrangement, configuration, and/or the like may be used.

In some embodiments, the electrical connectors 12 and 14 mate together within and/or on an intermediate structure. For example, in the illustrated embodiment, the electrical connectors 12 and 14 mate together within a corresponding port 38 of the common housing 24. The common housing 24 is optionally shielded (e.g., having at least a portion that is electrically conductive, being electrically connected to a source of electrical ground, and/or the like) to facilitate containing electromagnetic interference (EMI) and/or shielding the electrical connectors 12 and 14 from EMI. Another example of an intermediate structure is a cage for a pluggable transceiver module. In other embodiments, the electrical connectors 12 and 14 mate together without any intermediate structure.

Although each of the electrical connectors 12 and 14 is shown as terminating a respective cable 42 and 44, each electrical connector 12 and 14 may terminate any other device, such as, but not limited to a circuit board and/or the like. For example, in some embodiments the electrical connector 12 may terminate the cable 42, while the electrical connector 14 is mounted on a circuit board (not shown).

FIG. 2 is a perspective view of an embodiment of the electrical connector 12. The electrical connector 12 includes the housing 18 and the electrical contact assembly 26, which as shown in FIG. 2 is held by the housing 18 and includes the plug 34. As is also shown in FIG. 2, the electrical connector 12 terminates the cable 42 in the illustrated embodiment. The electrical connector 12 includes the latch 16. The latch 16 includes a body 46 that is mounted to the housing 18. The body 46 includes an actuator 48. As will be described below, the illustrated embodiment of the latch 16 is a pull latch wherein the actuator 48 is configured to be pulled to unlatch the latch 16.

The housing 18 includes a pair of opposite sidewalls 19a and 19b. As can be seen in FIG. 2, in the illustrated embodiment, the housing 18 is a two-piece structure that is formed by two shells 18a and 18b that connect together to define the housing 18. But, the housing 18 may be defined by any number of different structures (e.g., any number of shells and/or the like). In some embodiments, the housing 18 is formed from only a single, unitary structure. As can be seen in FIG. 2, each of the sidewalls 19a and 19b is defined by a portion of the shell 18a and a portion of the shell 18b in the illustrated embodiment.

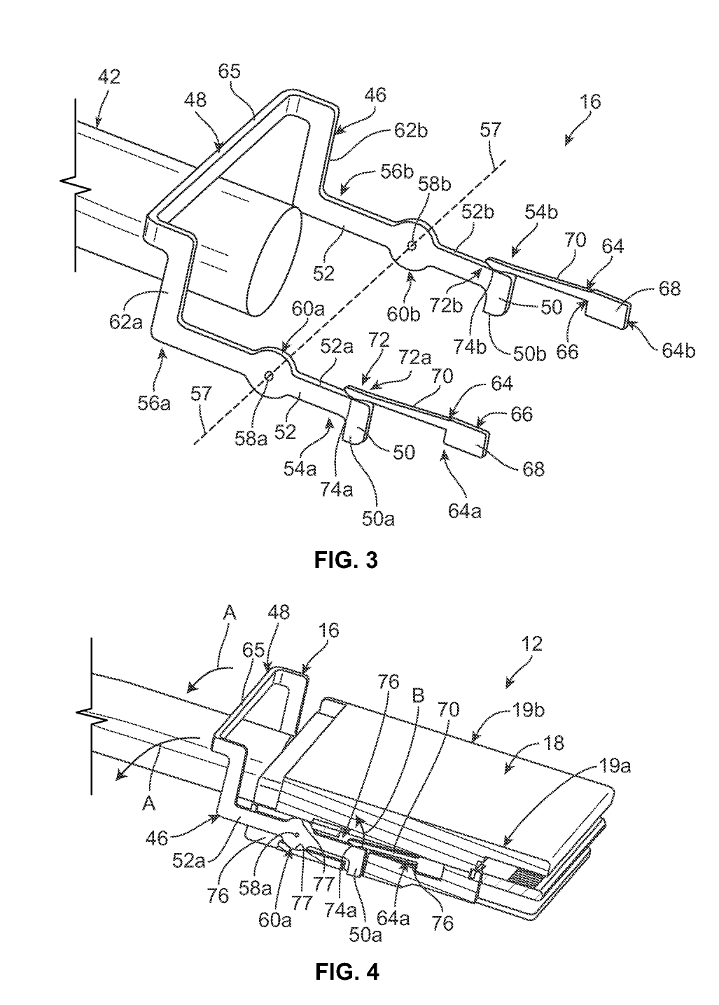

FIG. 3 is a perspective view of an embodiment of the latch 16. A portion of the cable 42 is also shown in FIG. 3. The latch 16 includes the body 46, which includes one or more latch pins 50, one or more last arms 52, and one or more of the actuators 48. In the illustrated embodiment, the body 46 includes two latch pins 50a and 50b and two latch arms 52a and 52b. Each of the latch pins 50a and 50b may be referred to herein as a “first” and/or a “second” latch pin. The latch arms 52a and 52b each may be referred to herein as a “first” and/or a “second” latch arm.

The latch arms 52a and 52b extend lengths from respective ends 54a and 54b to respective ends 56a and 56b. The latch pins 50a and 50b extend outward at the respective ends 54a and 54b of the respective latch arms 52a and 52b. In other words, the latch arms 52a and 52b extend outward from the respective latch pins 50a and 50b and from the respective ends 54a and 54b to the respective ends 56a and 56b. The latch pins 50a and 50b are not limited to the geometry (e.g., shape, size, and/or the like) shown herein. Rather, each of the latch pins 50a and 50b may have any other geometry in addition or alternatively to the geometry shown herein.

As will be described below, the latch pins 50a and 50b are movable between a latched position and unlatched position. In the illustrated embodiment, the body 46 of the latch 16 is configured to rotate about an axis 57 extending through pivot points 58a and 58b of the body 46 to thereby rotate latch pins 50a and 50b (about the respective pivot points 58a and 58b) between the latched position and the unlatched position. The latch arms 52a and 52b of the body 46 include respective pivot members 60a and 60b that cooperate with the housing 18 of the electrical connector 12 to enable the body 46 to rotate about the pivot points 58a and 58b. Although shown as being located at approximately a center of the lengths of the latch arms 52a and 52b, the pivot members 60a and 60b additionally or alternatively may be located at any other location along the length of the respective latch arms 52a and 52b. In the illustrated embodiment, the pivot members 60a and 60b are each curved protrusions that are complementary with a corresponding pivot member 77 (shown in FIG. 4) of the housing 18 (shown in FIGS. 1, 2, 4, and 5). Any other arrangements, configurations, geometries, and/or the like may be used in addition or alternative to the illustrated embodiments of the pivot members 60a and 60b.

In the illustrated embodiment, the actuator 48 extends from the end 56a to the end 56b of the latch arms 52a and 52b, respectively. But, additionally or alternatively the actuator 48 may extend from any other location along the lengths of the latch arms 52a and 52b. The actuator 48 includes base members 62a and 62b that extend from the latch arms 52a and 52b, respectively. The actuator 48 includes a bar 65 that extends a length from the base member 62a to the base member 62b. The bar 65 thus extends between the base members 62a and 62b. As will be described below, the actuator bar 65 is configured to rotate about the axis 57 to thereby rotate the latch pins 50a and 50b between the latched and unlatched position. Each of the base members 62a and 62b may be referred to herein as a “first” and/or a “second” base member.

The various components of the body 46 of the latch 16 are integrally fabricated from the same sheet of material as a continuous structure such that the body 46 is a single, unitary body. For example, the actuator 48, the latch arms 52a and 52b, and the latch pins 50a and 50b are integrally fabricated from the same sheet of material as a continuous structure such that the body 46 is a single, unitary body. One example of a process for integrally fabricating the various components of the body 46 from the same sheet of material as a continuous structure includes cutting the body 46 from a sheet of material and forming the cut structure into the finished shape of the body 46 shown herein, which may be referred to herein as a “cut and formed” body. Any cutting process(es) may be used to fabricate the body 46 as a cut and formed body, such as, but not limited to, stamping, laser cutting, water cutting, plasma cutting, cutting using a cutting tool (e.g., a saw, a blade, and/or the like), and/or the like. Moreover, any forming process(es) may be used to fabricate the body 46 as a cut and formed body, such as, but not limited to, compressive forming, tensile forming, combined compressive and tensile forming, bending, shearing, stamping, die forming, forging, indenting, rolling, stretching, expanding, recessing, deep drawing, spinning, flange forming, upset bulging, and/or the like. In some embodiments, the body 46 is a stamped and formed body that is stamped from a sheet of material. In such embodiments wherein the body 46 is a stamped and formed body, any other type and/or number of forming methods optionally may be used in addition to the stamping process(es) to fabricate the body 46 as a stamped and formed body.

Integrally fabricating the various components of the body 46 from the same sheet of material as a continuous structure such that the body 46 is a single, unitary body, for example using a cutting and forming process, may reduce a cost of the electrical connector 12, for example as compared to at least some known electrical connectors that include latches.

The latch 16 includes one or more return springs 64 operatively connected with the body 46 of the latch 16 such that the return spring(s) 64 is configured to bias the latch pins 50a and 50b to the latched position, as will be described below. The latch 16 may include any number of the return springs 64. In the illustrated embodiment, the latch 16 includes two return springs 64a and 64b. Each return spring 64 includes a body 66 having a base 68 and a spring finger 70 that extends outward from the base 68 to a free end 72 of the spring finger 70. As will be described below, an engagement surface 74a of the free end 72a of the return spring 64a is configured to engage in physical contact with the latch arm 52a to bias the latch pin 50a to the latched position. Similarly, an engagement surface 74b of the free end 72b of the return spring 64b is configured to engage in physical contact with the latch arm 52b to bias the latch pin 50b to the latched position. Any other geometry, configuration, arrangement, type of spring, and/or the like may be used in addition or alternatively to the illustrated embodiment of the body 66 of the return spring 64.

Optionally, the various components of the body 66 of the return spring 64 are integrally fabricated from the same sheet of material as a continuous structure such that the body 66 is a single, unitary body. For example, the base 68 and the spring finger 70 may be integrally fabricated from the same sheet of material as a continuous structure such that the body 66 is a single, unitary body. In some embodiments, the body 66 is a cut and formed body. Moreover, in some embodiments, the body 66 is a stamped and formed body that is stamped from a sheet of material. Optionally, any other type and/or number of forming methods may be used in addition to the stamping process(es) to fabricate the body 66 as a stamped and formed body. Integrally fabricating the various components of the body 66 from the same sheet of material as a continuous structure such that the body 66 is a single, unitary body, for example using a cutting and forming process, may reduce a cost of the electrical connector 12, for example as compared to at least some known electrical connectors that include latches.

FIG. 4 is a partially cut-away perspective view of the electrical connector 12 illustrating the latch 16 mounted thereto. The housing 18 has been cut-away in FIG. 4 to illustrate a cross-section of the sidewall 19a. As shown in FIG. 4, the sidewall 19a includes one or more internal cavities 76. The sidewall 19a includes a pivot member 77 that cooperates with the pivot member 60a of the latch arm 52a to enable the body 46 of the latch 16 to rotate about the pivot point 58a. The pivot point 58a is defined by a geometric center of the pivot member 60a. In the illustrated embodiment, the pivot member 77 is a cradle that is complementary with the pivot member 60a for receiving the pivot member 60a therein. Any other arrangements, configurations, geometries, and/or the like may be used in addition or alternative to the illustrated embodiment of the pivot member 77.

The return spring 64a and at least portions of the latch pin 50a and the latch arm 52a are held within the internal cavity 76 of the sidewall 19a. The pivot member 60a of the latch arm 52a is received within the cradle of the pivot member 77 such that the body 46 of the latch 16 is configured to rotate about the pivot point 58a. As should be appreciated from the above description of the sidewall 19a and a comparison of FIGS. 2 and 4, the return spring 64a can be considered to be embedded within the sidewall 19a because the return spring 64a is received within the internal cavity 76 of the sidewall 19a. The portions of the latch pin 50a and the latch arm 52a that extend within the internal cavity 76 of the sidewall 19a can also be considered to be embedded within the sidewall 19a. As shown in FIG. 4, the engagement surface 74a of the spring finger 70 of the return spring 64a is engaged in physical contact with the body 46 of the latch 16, and specifically with the latch arm 52a, within the internal cavity 76 of the sidewall 19a.

The other sidewall 19b of the housing 18 is substantially similar to the sidewall 19a and therefore will not be described in more detail herein. The return spring 64b (shown in FIG. 3) and the latch arm 52b (shown in FIG. 3) are received within the sidewall 19b in a substantially similar manner as the manner described above with respect to the sidewall 19a. The latch arm 52b cooperates with the housing 18 at the sidewall 19b in a substantially similar manner to the manner described above with respect to the latch arm 52a, which enables the body 46 of the latch 16 to rotate about the pivot points 58a and 58b (shown in FIG. 3).

Embedding the latch arms 52, the latch pins 50, and/or the return springs 64 within the sidewalls 19 may reduce the size of the electrical connector 12, for example as compared to at least some known electrical connectors that include latches. Moreover, embedding the latch arms 52, the latch pins 50, and/or the return spring 64 within the sidewalls 19 may improve the form factor of the electrical connector 12 as compared to at least some known electrical connectors that include latches. For example, embedding the latch arms 52, the latch pins 50, and/or the return spring 64 within the sidewalls 19 may prevent, or reduce the occurrence of snagging the electrical connector 12 on other objects, structures, the common housing 24 (shown in FIG. 1) and/or the like. Embedding the latch arms 52, the latch pins 50, and/or the return springs 64 within the sidewalls 19 may improve the aesthetics of the electrical connector 12 as compared to at least some known electrical connectors that include latches.

The latch pins 50a and 50b (shown in FIG. 3) are shown in the latched position in FIG. 4, with the spring fingers 70 of the return springs 64a and 64b (shown in FIG. 3) in the natural resting positions thereof. As shown in FIG. 4, when the spring finger 70 is in the natural resting position, the engagement surface 74 of the spring finger 70 is engaged in physical contact with the corresponding latch arm 50 such that the spring finger 70 biases the corresponding latch pin 50 to the latched position.

To move the latch 16 from the latched position shown in FIG. 4 to the unlatched position, the actuator bar 65 is pulled in the general direction of the arc A such that the actuator 48 rotates about the pivot points 58a and 58b along the arc A, which rotates the latch pins 50a and 50b against the bias of the spring fingers 70 and about the pivot points 58a and 58b along the arc B from the latched position to the unlatched position. The latch 16 is thus a pull latch wherein the actuator 48 is configured to be pulled to unlatch the latch 16. The actuator bar 65 may be pulled in the direction of the arc A using any portion of a person's hand (e.g., a finger, thumb, and/or the like) and/or using a suitable tool. In other embodiments, the actuator 48 is configured to be pushed to unlatch the latch 16 such that the latch 16 is a push latch (e.g., see the latch 116 shown in FIGS. 6-8).

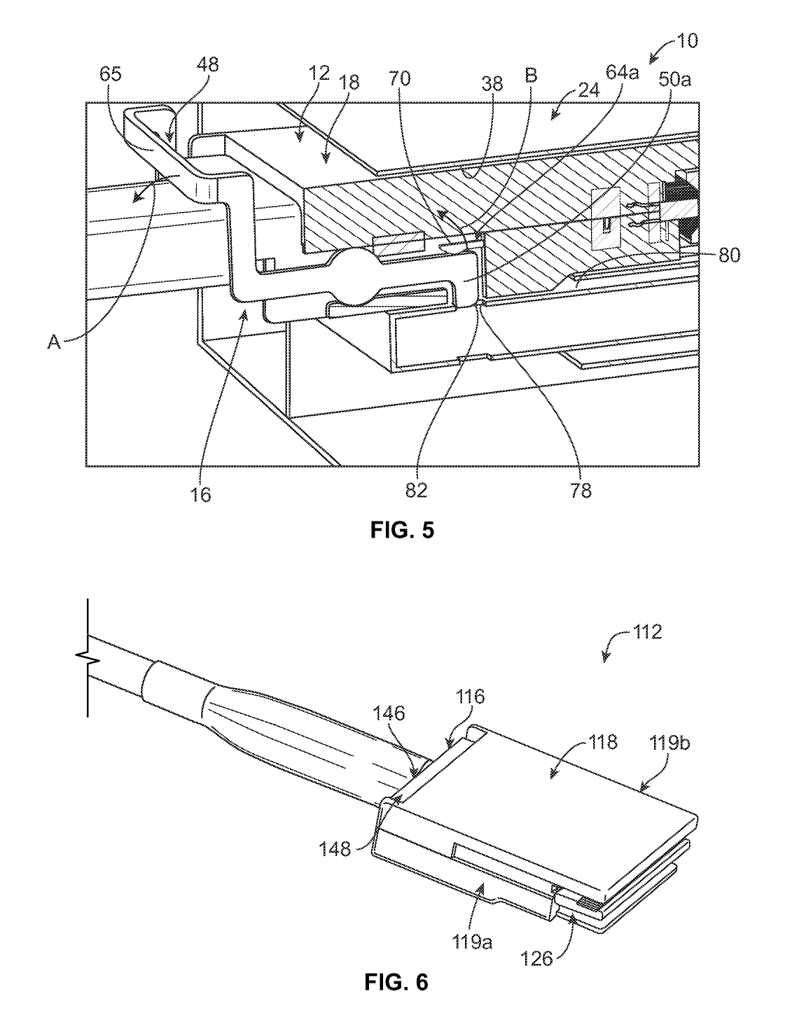

FIG. 5 is a partially cut-away perspective view illustrating a cross-section of a portion of the electrical connector assembly 10. The electrical connector 12 is shown in FIG. 5 as plugged into the corresponding port 38 (not shown in FIG. 4) of the common housing 24 (not shown in FIG. 4). As shown in FIG. 5, the latch pin 50a is received within a latch opening 78 of a wall 80 of the common housing 24 when the latch pin 50a is in the latched position. The reception of the latch pin 50a within the latch opening 78 latches the electrical connector 12 as plugged into the corresponding port 38 (and facilitates retaining, or latching, the electrical connector 12 as mated to the electrical connector 14 shown in FIG. 1). Although not visible in FIG. 5, the latch pin 50b (shown in FIG. 3) is received within a corresponding latch opening 78 of the wall 80 of the common housing 24 in a substantially similar manner to the manner described and illustrated herein with respect to the latch pin 50a.

The latch 16 can be unlatched using the actuator 48 to remove the electrical connector 12 from the port 38 and thereby de-mate the electrical connector 12 from the electrical connector 14. Specifically, the actuator bar 65 can be pulled in the general direction of the arc A such that the actuator 48 rotates along the arc A, which rotates the latch pins 50a and 50b (against the bias of the return springs 64a and 64b) along the arc B from the latched position to the unlatched position of the latch 16.

To plug the electrical connector 12 into the corresponding port 38, the actuator bar 65 can be held against the bias of the return springs 64a and 64b (shown in FIG. 3) to retain the latch pins 50a and 50b in the unlatched position as the electrical connector 12 is inserted into the port 38. Additionally or alternatively, engagement in physical contact with the wall 80 may move the latch pins 50a and/or 50b away from the latched position, against the bias of the return springs 64a and 64b, as the electrical connector 12 is inserted into the port 38. Once the electrical connector 12 has been inserted sufficiently deep into the corresponding port 38, the return springs 64a and 64b force the latch pins 50a and 50b into the corresponding latch openings 78. Optionally, the latch pin 50a and/or 50b includes a ramp surface 82 to facilitate engagement with the wall 80.

In the illustrated embodiment, the latch 16 latches the electrical connector 12 to the common housing 24. But, the latch 16 may latch the electrical connector 12 to any other device, such as, but not limited to, the housing 20 (shown in FIG. 1) of the electrical connector 14, a cage, and/or the like.

FIG. 6 is a perspective view of another embodiment of an electrical connector 112 illustrating another embodiment of a latch 116. The electrical connector 112 includes a housing 118 and an electrical contact assembly 126, which is held by the housing 118. The housing 118 includes a pair of opposite sidewalls 119a and 119b. The latch 116 includes a body 146 that is mounted to the housing 118. The body 146 includes an actuator 148. The latch 116 is a push latch wherein the actuator 148 is configured to be pushed to unlatch the latch 116.

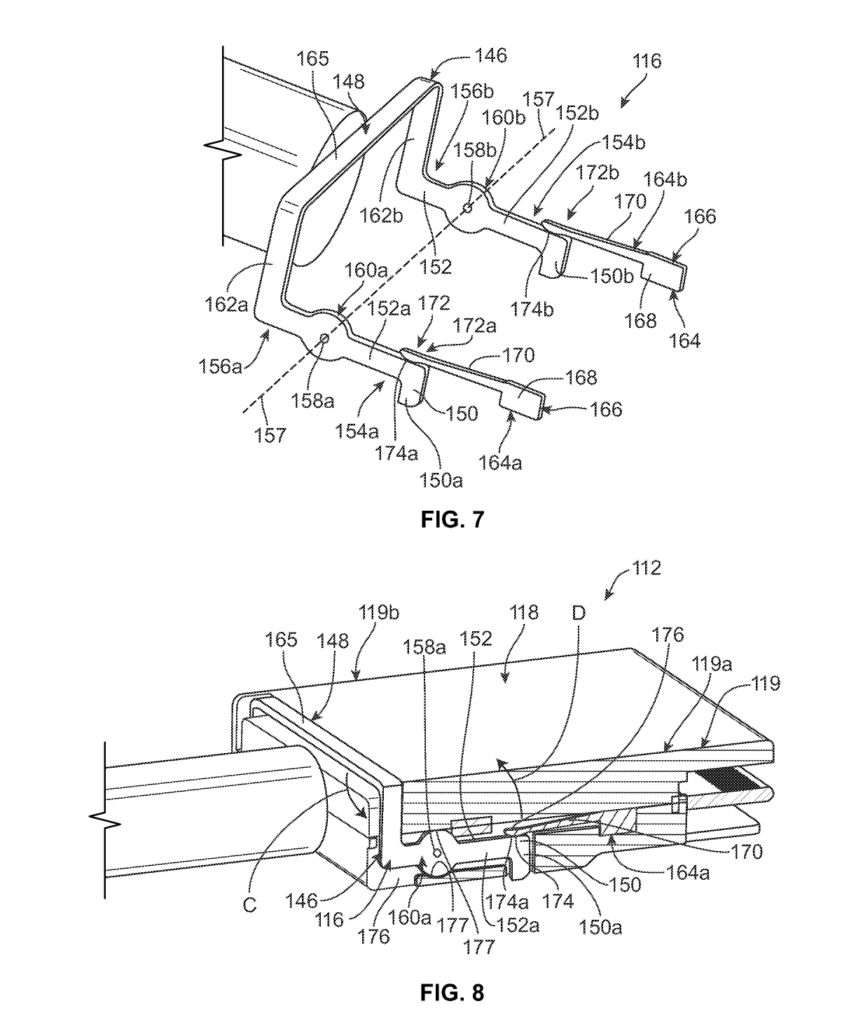

FIG. 7 is a perspective view of an embodiment of the latch 116. The latch 116 includes the body 146, which includes one or more latch pins 150, one or more latch arms 152, and one or more of the actuators 148. In the illustrated embodiment, the body 146 includes two latch pins 150a and 150b and two latch arms 152a and 152b. Each of the latch pins 150a and 150b may be referred to herein as a “first” and/or a “second” latch pin. The latch arms 152a and 152b each may be referred to herein as a “first” and/or a “second” latch arm.

The latch arms 152a and 152b extend lengths from respective ends 154a and 154b to respective ends 156a and 156b. The latch pins 150a and 150b extend outward at the respective ends 154a and 154b of the respective latch arms 152a and 152b. In other words, the latch arms 152a and 152b extend outward from the respective latch pins 150a and 150b and from the respective ends 154a and 154b to the respective ends 156a and 156b. The latch pins 150a and 150b are not limited to the geometry (e.g., shape, size, and/or the like) shown herein. Rather, each of the latch pins 150a and 150b may have any other geometry in addition or alternatively to the geometry shown herein.

The latch pins 150a and 150b are movable between a latched position and unlatched position. In the illustrated embodiment, body 146 of the latch 116 is configured to rotate about an axis 157 extending through pivot points 158a and 158b of the body 146 to thereby rotate latch pins 150a and 150b (about the respective pivot points 158a and 158b) between the latched position and the unlatched position. The latch arms 152a and 152b of the body 146 include respective pivot members 160a and 160b that cooperate with the housing 118 (shown in FIGS. 6 and 8) of the electrical connector 112 to enable the body 146 to rotate about the pivot points 158a and 158b. The pivot points 158a and 158b are defined by geometric centers of the pivot members 160a and 160b, respectively. Although shown as being located at approximately a center of the lengths of the latch arms 152a and 152b, the pivot members 160a and 160b additionally or alternatively may be located at any other location along the length of the respective latch arms 152a and 152b. In the illustrated embodiment, the pivot members 160a and 160b are each curved protrusions that are complementary with a corresponding pivot member 177 (shown in FIG. 8) of the housing 118. Any other arrangements, configurations, geometries, and/or the like may be used in addition or alternative to the illustrated embodiments of the pivot members 160a and 160b.

In the illustrated embodiment, the actuator 148 extends from the end 156a to the end 156b of the latch arms 152a and 152b, respectively. But, additionally or alternatively the actuator 148 may extend from any other location along the lengths of the latch arms 152a and 152b. The actuator 148 includes base members 162a and 162b that extend from the latch arms 152a and 152b, respectively. The actuator 148 includes a bar 165 that extends a length from the base member 162a to the base member 162b. The bar 165 thus extends between the base members 162a and 162b. The actuator bar 165 is configured to rotate about the axis 157 to thereby rotate the latch pins 150a and 150b between the latched and unlatched position. Each of the base members 162a and 162b may be referred to herein as a “first” and/or a “second” base member.

The various components of the body 146 of the latch 116 are integrally fabricated from the same sheet of material as a continuous structure such that the body 146 is a single, unitary body. For example, the actuator 148, the latch arms 152a and 152b, and the latch pins 150a and 150b are integrally fabricated from the same sheet of material as a continuous structure such that the body 146 is a single, unitary body. In some embodiments, the body 146 is a cut and formed body. Moreover, in some embodiments, the body 146 is a stamped and formed body that is stamped from a sheet of material. Optionally, any other type and/or number of forming methods optionally may be used in addition to the stamping process(es) to fabricate the body 146 as a stamped and formed body. Integrally fabricating the various components of the body 146 from the same sheet of material as a continuous structure such that the body 146 is a single, unitary body, for example using a cutting and forming process, may reduce a cost of the electrical connector 112, for example as compared to at least some known electrical connectors that include latches.

The latch 116 includes one or more return springs 164 operatively connected with the body 146 of the latch 116 such that the return spring(s) 164 is configured to bias the latch pins 150a and 150b to the latched position. The latch 116 may include any number of the return springs 164. In the illustrated embodiment, the latch 116 includes two return springs 164a and 164b. Each return spring 164 includes a body 166 having a base 168 and a spring finger 170 that extends outward from the base 168 to a free end 172 of the spring finger 170. An engagement surface 174a of the free end 172a of the return spring 164a is configured to engage in physical contact with the latch arm 152a to bias the latch pins 150a and 150b to the latched position. Similarly, an engagement surface 174b of the free end 172b of the return spring 164b is configured to engage in physical contact with the latch arm 152b to bias the latch pins 150a and 150b to the latched position. Any other geometry, configuration, arrangement, type of spring, and/or the like may be used in addition or alternatively to the illustrated embodiment of the body 166 of the return spring 164.

Optionally, the various components of the body 166 of the return spring 164 are integrally fabricated from the same sheet of material as a continuous structure such that the body 166 is a single, unitary body. For example, the base 168 and the spring finger 170 may be integrally fabricated from the same sheet of material as a continuous structure such that the body 166 is a single, unitary body. In some embodiments, the body 166 is a cut and formed body. Moreover, in some embodiments, the body 166 is a stamped and formed body that is stamped from a sheet of material. Optionally, any other type and/or number of forming methods may be used in addition to the stamping process(es) to fabricate the body 166 as a stamped and formed body. Integrally fabricating the various components of the body 166 from the same sheet of material as a continuous structure such that the body 166 is a single, unitary body, for example using a cutting and forming process, may reduce a cost of the electrical connector 112, for example as compared to at least some known electrical connectors that include latches.

FIG. 8 is a partially cut-away perspective view of the electrical connector 112 illustrating the latch 116 mounted thereto. The housing 118 has been cut-away in FIG. 8 to illustrate a cross-section of the sidewall 119a. As shown in FIG. 8, the sidewall 119a includes one or more internal cavities 176. The sidewall 119a includes a pivot member 177 that cooperates with the pivot member 160a of the latch arm 152a to enable the body 146 of the latch 116 to rotate about the pivot point 158a. In the illustrated embodiment, the pivot member 177 is a cradle that is complementary with the pivot member 160a for receiving the pivot member 160a therein. Any other arrangements, configurations, geometries, and/or the like may be used in addition or alternative to the illustrated embodiment of the pivot member 177.

The return spring 164a and at least portions of the latch pin 150a and the latch arm 152a are held within the internal cavity 176 of the sidewall 119a. The pivot member 160a of the latch arm 152a is received within the cradle of the pivot member 177 such that the body 146 of the latch 116 is configured to rotate about the pivot point 158a. As should be appreciated from the above description of the sidewall 119a and a comparison of FIGS. 6 and 8, the return spring 164a can be considered to be embedded within the sidewall 119a because the return spring 164a is received within the internal cavity 176 of the sidewall 119a. The portions of the latch pin 150a and the latch arm 152a that extend within the internal cavity 176 of the sidewall 119a can also be considered to be embedded within the sidewall 119a. As shown in FIG. 8, the engagement surface 174a of the spring finger 170 of the return spring 164a is engaged in physical contact with the body 146 of the latch 116, and specifically with the latch arm 152a, within the internal cavity 176 of the sidewall 119a.

The other sidewall 119b of the housing 118 is substantially similar to the sidewall 119a and therefore will not be described in more detail herein. The return spring 164b (shown in FIG. 7) and the latch arm 52b (shown in FIG. 7) are received within the sidewall 119b in a substantially similar manner as the manner described above with respect to the sidewall 119a. The latch arm 152b cooperates with the housing 118 at the sidewall 119b in a substantially similar manner to the manner described above with respect to the latch arm 152a, which enables the body 146 of the latch 116 to rotate about the pivot points 158a and 158b (shown in FIG. 7).

Embedding the latch arms 152, the latch pins 150, and/or the return springs 164 within the sidewalls 119 may reduce the size of the electrical connector 112, for example as compared to at least some known electrical connectors that include latches. Moreover, embedding the latch arms 152, the latch pins 150, and/or the return springs 164 within the sidewalls 119 may improve the form factor of the electrical connector 112 as compared to at least some known electrical connectors that include latches. For example, embedding the latch arms 152, the latch pins 150, and/or the return springs 164 within the sidewalls 119 may prevent, or reduce the occurrence of snagging the electrical connector 112 on other objects, structures, and/or the like. Embedding the latch arms 152, the latch pins 150, and/or the return spring 164 within the sidewalls 119 may improve the aesthetics of the electrical connector 112 as compared to at least some known electrical connectors that include latches.

The latch pins 150a and 150b (shown in FIG. 3) are shown in the latched position in FIG. 8, with the spring fingers 170 of the return springs 164a and 164b (shown in FIG. 3) in the natural resting positions thereof. As shown in FIG. 8, when the spring finger 170 is in the natural resting position, the engagement surface 174 of the spring finger 170 is engaged in physical contact with the corresponding latch arm 150 such that the spring finger 170 biases the latch pins 150a and 150b to the latched position.

To move the latch 116 from the latched position shown in FIG. 8 to the unlatched position, the actuator bar 165 is pushed in the general direction of the arc C such that the actuator 148 rotates about the pivot points 158a and 158b along the arc C, which rotates the latch pins 150a and 150b, against the bias of the spring fingers 170, about the pivot points 158a and 158b along the arc D from the latched position to the unlatched position. The latch 116 is thus a push latch wherein the actuator 148 is configured to be pushed to unlatch the latch 116. The actuator bar 165 may be pushed in the direction of the arc C using any portion of a person's hand (e.g., a finger, thumb, and/or the like) and/or using a suitable tool. In other embodiments, the actuator 148 is configured to be pulled to unlatch the latch 116 such that the latch 116 is a pull latch (e.g., see the latch 16 shown in FIGS. 1-5).

Although shown as being used with the particular electrical connectors 12, 14, and 112, the latch embodiments shown and/or described herein may be used with any other type of electrical connector. One specific example of another type of electrical connector with which the latch embodiments shown and/or described herein may be used is a pluggable transceiver module (not shown).

The latch embodiments described and/or illustrated herein may provide a relatively robust, reliable, and/or cost effective latch that is biased to the latched position in a minimal envelope.

It is to be understood that the above description is intended to be illustrative, and not restrictive. For example, the above-described embodiments (and/or aspects thereof) may be used in combination with each other. In addition, many modifications may be made to adapt a particular situation or material to the teachings of the invention without departing from its scope. Dimensions, types of materials, orientations of the various components, and the number and positions of the various components described herein are intended to define parameters of certain embodiments, and are by no means limiting and are merely exemplary embodiments. Many other embodiments and modifications within the spirit and scope of the claims will be apparent to those of skill in the art upon reviewing the above description. The scope of the invention should, therefore, be determined with reference to the appended claims, along with the full scope of equivalents to which such claims are entitled. In the appended claims, the terms “including” and “in which” are used as the plain-English equivalents of the respective terms “comprising” and “wherein.” Moreover, in the following claims, the terms “first,” “second,” and “third,” etc. are used merely as labels, and are not intended to impose numerical requirements on their objects. Further, the limitations of the following claims are not written in means—plus-function format and are not intended to be interpreted based on 35 U.S.C. §112, sixth paragraph, unless and until such claim limitations expressly use the phrase “means for” followed by a statement of function void of further structure.

What is claimed is:

1. A latch for latching a connector to a device, the latch comprising:
a body comprising an actuator and a latch pin, the latch pin being movable between a latched position and an unlatched position, wherein the latch pin is configured to latch the connector to the device when the latch pin is in the latched position, the actuator extending from the latch pin, the actuator being configured such that movement of the actuator moves the latch pin between the latched position and the unlatched position; and
wherein the actuator and the latch pin are integrally fabricated from a same sheet of material as a continuous structure such that the body is a single, unitary body.

2. The latch of claim 1, wherein the body is a stamped and formed body that is stamped from the sheet of material.

3. The latch of claim 1, further comprising a return spring operatively connected with the body such that the return spring is configured to bias the latch pin to the latched position.

4. The latch of claim 1, further comprising a return spring operatively connected with the body such that the return spring is configured to bias the latch pin to the latched position, the return spring comprising a body fabricated from a sheet of material as a single, unitary body.

5. The latch of claim 1, wherein the actuator is configured to rotate about a pivot point of the body, and wherein rotation of the actuator about the pivot point rotates the latch pin about the pivot point between the latched position and the unlatched position.

6. The latch of claim 1, wherein the latch pin is a first latch pin, the body further comprising a second latch pin, first and second latch arms that extend outward from the first and second latch pins, respectively, and first and second base members that extend from the first and second latch arms, respectively, the actuator comprising a bar that extends between the first and second base members.

7. The latch of claim 1, wherein the actuator is configured to be pulled to move the latch pin from the latched position to the unlatched position.

8. The latch of claim one, wherein the actuator is configured to be pushed to move the latch pin from the latched position to the unlatched position.

9. The latch of claim 1, wherein the device comprises at least one of a cage, a common housing for the connector and another connector that mates with the connector, or a housing of another connector that mates with the connector.

10. An electrical connector comprising:
a housing;
an electrical contact assembly held by the housing; and
a latch mounted to the housing for latching the electrical connector to a device, the latch comprising:
a body comprising an actuator and a latch pin, the latch pin being movable between a latched position and an unlatched position, wherein the latch pin is configured to latch the electrical connector to the device when the latch pin is in the latched position, the actuator extending from the latch pin, the actuator being configured such that movement of the actuator moves the latch pin between the latched position and the unlatched position; and
wherein the actuator and the latch pin are integrally fabricated from a same sheet of material as a continuous structure such that the body is a single, unitary body.

11. The electrical connector of claim 10, wherein the body is a stamped and formed body that is stamped from the sheet of material.

12. The electrical connector of claim 10, further comprising a return spring operatively connected with the body such that the return spring is configured to bias the latch pin to the latched position, the return spring comprising a body fabricated from a sheet of material as a single, unitary body.

13. The electrical connector of claim 10, further comprising a return spring operatively connected with the body such that the return spring is configured to bias the latch pin to the latched position, the return spring being embedded within a sidewall of the housing.

14. The electrical connector of claim 10, further comprising a return spring operatively connected with the body such that the return spring is configured to bias the latch pin to the latched position, the return spring being configured to engage in physical contact with the body of the latch within a sidewall of the housing to bias the latch pin to the latched position.

15. The electrical connector of claim 10, wherein the body of the latch comprises a latch arm that extends outward from the latch pin to the actuator, at least a portion of the latch arm and at least a portion of the latch pin being embedded within a sidewall of the housing.

16. The electrical connector of claim 10, wherein the actuator is configured to rotate about a pivot point of the body, and wherein rotation of the actuator about the pivot point rotates the latch pin about the pivot point between the latched position and the unlatched position.

17. The electrical connector of claim 10, wherein the latch pin is a first latch pin, the body further comprising a second latch pin, first and second latch arms that extend outward from the first and second latch pins, respectively, and first and second base members that extend from the first and second latch arms, respectively, the actuator comprising a bar that extends between the first and second base members.

18. An electrical connector comprising:
a housing comprising a sidewall;
an electrical contact assembly held by the housing; and
a latch mounted to the housing for latching the electrical connector to a device, the latch comprising:
a body comprising an actuator and a latch pin, the latch pin being movable between a latched position and an unlatched position, wherein the latch pin is configured to latch the electrical connector to the device when the latch pin is in the latched position, the actuator extending from the latch pin, the actuator being configured such that movement of the actuator moves the latch pin between the latched position and the unlatched position; and
a return spring operatively connected with the body such that the return spring is configured to bias the latch pin to the latched position, wherein the return spring is embedded within the sidewall of the housing.

19. The electrical connector of claim 18, wherein the return spring is configured to engage in physical contact with the body of the latch within the sidewall of the housing to bias the latch pin to the latched position.

20. The electrical connector of claim 18, wherein the return spring comprises a body fabricated from a sheet of material as a single, unitary body.
